(19) United States
(12) Patent Application Publication
(10) Pub. No.: US 2024/0043681 A1
(43) Pub. Date: Feb. 8, 2024

(54) Polymer Structure Comprising Base Plastic With Hydration Layer For Avoiding Biofilm Formation Thereon

(71) Applicant: Nano and Advanced Materials Institute Limited, Hong Kong (HK)

(72) Inventors: Wenjun MENG, Hong Kong (HK); Deryck Hin Yeung LI, Hong Kong (HK); Jihan YI, Hong Kong (HK); Jingyu SHI, Hong Kong (HK); Kevin TSAI, Hong Kong (HK)

(21) Appl. No.: 18/258,331

(22) PCT Filed: Dec. 22, 2021
(86) PCT No.: PCT/CN2021/140640

§ 371 Date: Jun. 20, 2023

Related U.S. Application Data
(60) Provisional application No. 63/129,611, filed on Dec. 23, 2020.

(51) Int. Cl. C08L 55/02; C08J 3/22

(52) U.S. Cl. CPC C08L 55/02; C08J 3/226; C08L 2310/00; C08J 2423/12; C08J 2423/14; C08J 2355/02

(57) ABSTRACT

Provided is a germ-repellent polymer structure including a base plastic selected from polypropylene homopolymer, polypropylene impact copolymer, or acrylonitrile butadiene styrene; and a hydration layer, the hydration layer including one or more hydrophilic additives formed on the base plastic optionally in the presence of an intermediate plastic that is compatible to both the base plastic and hydrophilic additives for stabilizing the hydration layer on some base plastics. In some embodiment, the introduction of hydration layer to the base plastic through the intermediate plastic imparts germ repellency by introducing sufficient hydroxyl groups onto the surface of the base plastic in order to trap water molecules into a polymer matrix of the base plastic. The change in mechanical strength of the base plastic before and after the introduction of the hydration layer is less than 20% of an original mechanical strength, where the original mechanical strength corresponds to a strength of the base plastic before formation of the hydration layer.

### CROSS-REFERENCE TO RELATED APPLICATION

This application claims priority from the U.S. provisional patent application No. 63/129,611 filed Dec. 23, 2020, and the disclosure of which is incorporated herein by reference in its entirety.

### TECHNICAL FIELD

The present invention relates to the field of polymer modification, in particular, a polymer structure comprising a base plastic and a hydration layer for avoiding biofilm formation thereon.

### BACKGROUND

Plastic surfaces are a potential site for bacterial growth and a bacteria-populated slimy film, called biofilm, tends to develop thereon. Biofilms present a health hazard to humans and increases the chance of microbial infections.

Conventional antibacterial plastic involves the introduction of biocides or antimicrobial agents to the plastic surface, e.g., introducing heavy metal such as silver and/or its derivatives by binding the same to the plastic surface through chemical or irradiation treatment. The killing effect of this kind of biocide or antimicrobial agent on bacteria may entail the leaching of the content inside bacterial cells in an uncontrolled manner. The leaching of bacterial content, biocides, or antimicrobial agents to the plastic surface during and after the killing mechanism by the biocides or antimicrobial agents may cause irritation to whoever is in close contact with the plastic surface. Other possible drawbacks of using this kind of biocide or antimicrobial agent include potential deterioration of the plastic itself by leaching of silver ions; possible development into biocide-resistant microbes if they are undertreated; bacteria can still grow on inactive layer of biofilm if the inactive biofilm is not removed from the plastic surface.

A safe, non-leaching, biocide-free solution to make plastic surface resistant to bacterial growth by preventing its adhesion and colonization is one of the alternatives to the biocides or bacteria-killing actives.

Most of the existing non-leaching, biocide-free solutions to make a plastic surface resistant to adhesion and colonization of bacteria function by introducing a hydrophilic layer via physical, chemical or covalent attachment to the target plastic before or during extrusion of the plastic. Some known hydrophilic agents or additives forming such a hydrophilic layer on the plastic include poly(ethylene glycol) (PEG), chitosan, polycations, and zwitterionic polymers. The hydrophilic layer exhibits anti-fouling effect on non-specific adhesion and potential colonization of bacterial growth on a plastic surface.

Some widely used commodity plastics, e.g., polystyrene, polyvinyl chloride, polypropylene and polyethylene, have relatively poorer mechanical and thermal properties than engineering plastics. Polypropylene (PP) and its derivatives, e.g., polypropylene homopolymer (PPH) and polypropylene impact copolymer (PPIC), and acrylonitrile butadiene styrene (ABS), after being surface modified by some commonly used hydrophilic agents, because those hydrophilic agents are incompatible to the base polymers (most of them are hydrophobic), the mechanical properties of the base polymers are therefore worsened, causing them to become brittle.

In U.S. Pat. No. 10,525,614, the present inventors had used a highly hydrophilic modifier, PEG10K, to modify polypropylene resin in the presence of a maleic anhydride-grafted olefin plastomer as a compatibilizer to produce a germ-repellent polypropylene resin. However, the present inventors found that because of the hydrophobic nature of PP resin polymer backbone, although the afore-mentioned compatibilizer was used to facilitate the association between the polypropylene resin and the hydrophilic modifier, it seems that such compatibilizer itself was not enough to orient the hydrophilic groups of the hydrophilic modifier away from the hydrophobic polymer matrix, lowering the surface hydrophilicity of the modified polypropylene resin.

To solve this potential problem existing in many conventional germ-repellent plastics being surface-modified by grafting a hydrophilic agent thereon which could not provide an effective germ-repellent surface as expected, but on the other hand, severely affect the mechanical properties of the plastic itself, selecting a matching hydrophilic agent to these plastics with a hydrophobic polymer matrix appears to be a key to success in this aspect. However, it is hard to select a matching hydrophilic agent to the plastic of interest due to other external factors such as the manufacturing limitations that may restrict the use of some hydrophilic agents, e.g., an unmatched hydrophilic agent can always lead to slipping at the screw surface during the manufacturing. In this regard, there is a need for a new mechanism to associate the hydrophilic agent with the plastic of interest with negligible effects on the original bulk properties.

### SUMMARY OF THE INVENTION

In view of the foregoing problem, a first aspect of the present disclosure relates to a germ-repellent polymer structure including a base plastic selected from polypropylene homopolymer, polypropylene impact copolymer, or acrylonitrile butadiene styrene; and a hydration layer, the hydration layer including one or more hydrophilic additives optionally in the presence of an intermediate plastic that is compatible to both the base plastic and the hydrophilic additives for stabilizing the hydration layer on the base plastic. The introduction of hydration layer to the base plastic through the intermediate plastic imparts germ repellency by introducing sufficient hydroxyl groups onto the surface of the base plastic in order to trap water molecules into a polymer matrix of the base plastic. The change in mechanical strength of the base plastic before and after the introduction of the hydration layer is less than 20% of an original mechanical strength, where the original mechanical strength corresponds to a strength of the base plastic before formation of the hydration layer. Because the base plastic of the present invention is hydrophobic in nature, this kind of base plastic is unfavorable to the exposure of hydroxyl groups from the hydrophilic additives to render the plastic surface hydrophilic in order to resist the growth, propagation and/or colonization of the bacteria. Selecting hydrophilic additives matching the base plastic of the present invention to render its surface hydrophilic is important. Formation of biofilm is thereby avoided.

In an exemplary embodiment, approximately 0.1 to 20 wt. % of one or more hydrophilic additives, 60 to 90 wt. % of base plastic, and 0 to 20 wt. % of intermediate plastic are mixed to form a thorough mixture before extrusion.

More specifically, the one or more hydrophilic additives is approximately in a range of 0.1 to 5 wt. %; the base plastic is in a range of 85 to 99.9 wt. %; the intermediate plastic is in a range of 0 to 10 wt. %.

In an embodiment of the present invention, the intermediate plastic includes at least one polymeric segment compatible to the base plastic, and the intermediate plastic is selected from a maleic acid grafted copolymer or maleic anhydride grafted copolymer. Preferably, the intermediate plastic is maleic anhydride grafted copolymer.

In an embodiment, the one or more hydrophilic additives is/are selected from a hydrophilic non-ionic surfactant having at least one hydrophilic block of polyethylene glycol.

In another embodiment, the one or more hydrophilic additives is a triblock copolymer having two hydrophilic blocks of polyethylene glycol on both ends sandwiching a central hydrophobic block of polypropylene glycol with the following formula:

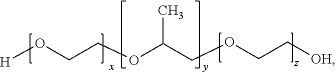

wherein x:y:z is 98-101:56:98-101.

More specifically, the triblock copolymer as the one or more hydrophilic additives with the foregoing formula associates with the base plastic of the present invention to orient the polyethylene glycol moiety of the hydrophilic additive towards the surface of the base plastic such that a reduction by at least 95% of the bacterial growth on said plastic surface is resulted.

In another embodiment, the one or more hydrophilic additives is a polyethylene glycol ether with the following formula:

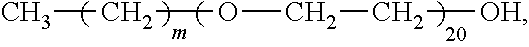

wherein m=15 or 17.

In yet another embodiment, the one or more hydrophilic additives is a polypropylene glycol glycerol ether with the following formula:

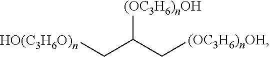

wherein n is an integer independently selected from 16-20.

In a further embodiment, the one or more hydrophilic additives is polyethylene glycol sorbitol hexaoleate.

In an embodiment, the present germ-repellent polymer structure further includes a slip additive for reducing surface friction and facilitating release of the base plastic from a mold.

In an embodiment, the slip additive is a compound with a formula of R—C(O)O—R′, wherein R and R′ represent C₁₋₃₄ hydrocarbons.

For example, the slip additive may be stearyl stearate, stearyl behenate, behenyl behenate, ethyl behenate, behenyl acetate, palmityl myristate, or palmityl palmate, or any other compounds disclosed in the UK patent under the patent number GB 2411616 A, which is incorporated herein by reference in its entirety. In general, the slip additive of this kind bears a trade name of Croda Incromax™ PS.

In an embodiment, the bacterial growth on the base plastic surface is a biofilm formed by bacteria selected from E. coli and S. aureus.

In an embodiment, the base plastic, one or more hydrophilic additives, and intermediate plastic form a masterbatch.

In an embodiment, the comingling of the base plastic, one or more hydrophilic additives and intermediate plastic is by melt extrusion.

A second aspect of the present invention relates to a method of making a germ-repellent plastic including the germ-repellent polymer structure of the present invention, where the method includes:
preparing a masterbatch comprising two or more of base plastic, hydrophilic additive and intermediate plastic to form a masterbatch;
injection molding base plastic and the masterbatch to form the germ-repellent polymer structure with germ-repellent properties of approximately 90% or higher reduction in bacterial growth on the surface of the base plastic,
wherein the base plastic is one or more selected from acrylonitrile butadiene styrene (ABS), polypropylene homopolymer (PPH), and/or polypropylene impact copolymer (PPIC); the hydrophilic additive is one or more selected from polypropylene glycol glycerol ether, poly(ethylene glycol) ether, polaxamer 407, and/or Atmer™ 7373 (an anti-fog additive from Croda); the intermediate plastic is one or more selected from styrene maleic anhydride (SMA), random polyolefin grafted maleic anhydride, ethylene, butyl acrylate, and maleic anhydride random terpolymer, and/or polypropylene grafted maleic anhydride.

In an embodiment, the masterbatch is prepared by comingling approximately 0.1 to 20 wt. % of one or more hydrophilic additives, 60 to 90 wt. % of base plastic, and 0 to 20 wt. % of intermediate plastic at a first temperature.

In an embodiment, the first temperature is from 110 to 230° C.; more specifically, the first temperature is from 110 to 200° C. or from 210 to 230° C.; and even more specifically, the first temperature is from 110 to 190° C., from 180 to 200° C., or from 210 to 230° C.

In an embodiment, the preparing of the masterbatch includes selecting the hydrophilic additives to match the base plastic before comingling thereof with one or both of the base plastic and/or intermediate plastic, selecting the hydrophilic additives that are capable of being homogeneously dispersed in the base plastic during a molten phase in extrusion and orienting the hydrophilic moiety of the hydrophilic additives to the surface of the base plastic during cooling phase after extrusion.

In a preferred embodiment, the intermediate plastic of the present invention includes a portion that is compatible to the polymer matrix of the base plastic, and a portion that is incompatible to the polymer matrix of the base plastic but is compatible to the hydrophilic additives and to facilitate the orientation of the hydrophilic moiety of the hydrophilic additives to the surface of the base plastic.

In an embodiment, the method further includes adding a slip additive before the injection molding.

In an embodiment, the slip additive is a compound with a formula of R—C(O)O—R′, wherein R and R′ represent C₁₋₃₄ hydrocarbons.

For example, the slip additive may be stearyl stearate, stearyl behenate, behenyl behenate, ethyl behenate, behenyl acetate, palmityl myristate, or palmityl palmate, or any other compounds disclosed in the UK patent under the patent number GB 2411616 A, which is incorporated herein by reference in its entirety. In general, the slip additive of this kind bears a trade name of Croda Incromax™ PS.

In an embodiment, the base plastic is ABS; the hydrophilic additive is polypropylene glycol glycerol ether; and the slip additive is Croda Incromax™ PS, wherein the base plastic and the hydrophilic additive are mixed to form the masterbatch, and the base plastic, the masterbatch and the slip additive are injection molded to form the germ-repellent polymer structure.

In another embodiment, the preparation of the masterbatch is by extrusion.

In other embodiment, the germ-repellent plastic after cooling from extrusion is pelletized to become pellets.

The present invention also provides plastic products or articles comprising the germ-repellent polymer structure of the present invention or polymer structure comprising hydration layer for avoiding biofilm formation thereon prepared according to the method of the present invention. Said products/articles include but not limited to toilet seat, waste trap/drainage pipes, flush valve, cistern, and shower head.

### BRIEF DESCRIPTION OF THE DRAWINGS

The disclosure will become more fully understood from the detailed description given herein below for illustration only, and thus not limitative of the disclosure, wherein:

FIG. 1 is a schematic diagram depicting an embodiment of the present invention involving the use of a processing aid to assist the orientation of hydrophilic moiety of the hydrophilic additives to the surface of the base plastic from molten phase followed by cooling phase after extrusion.

FIG. 2 illustrates schematically a typical example of a twin-screw extrusion process of preparing a germ-repellent polymer structure from base resin with germ-repellent modifiers according to an embodiment of the present invention.

FIG. 3 illustrates a process workflow of how to conduct a germ repellent efficacy test for plastic samples.

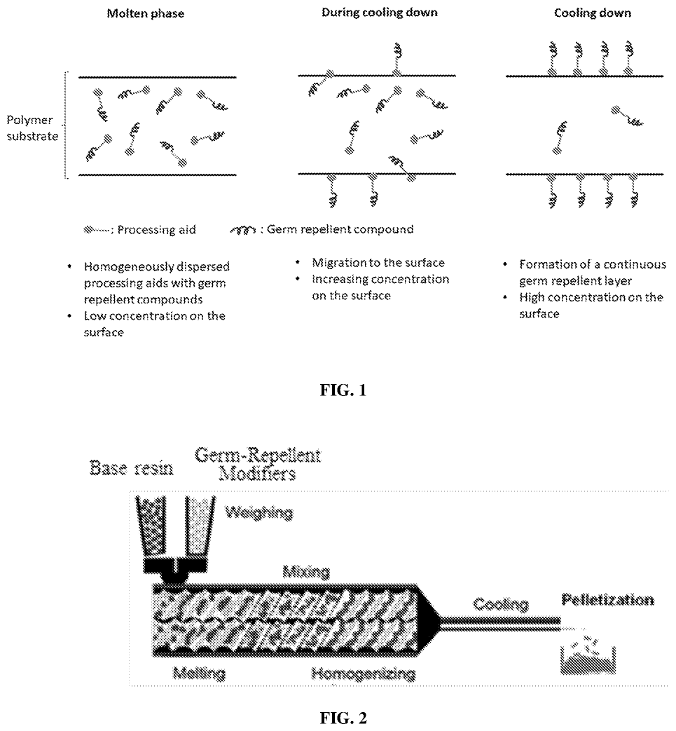

### DEFINITIONS

The terms “a” or “an” are used to include one or more than one and the term “or” is used to refer to a nonexclusive “or” unless otherwise indicated. In addition, it is to be understood that the phraseology or terminology employed herein, and not otherwise defined, is for the purpose of description only and not of limitation. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

In the methods of preparation described herein, the steps can be carried out in any order without departing from the principles of the invention, except when a temporal or operational sequence is explicitly recited. Recitation in a claim to the effect that first a step is performed, and then several other steps are subsequently performed, shall be taken to mean that the first step is performed before any of the other steps, but the other steps can be performed in any suitable sequence, unless a sequence is further recited within the other steps. For example, claim elements that recite “Step A, Step B, Step C, Step D, and Step E” shall be construed to mean step A is carried out first, step E is carried out last, and steps B, C, and D can be carried out in any sequence between steps A and E, and that the sequence still falls within the literal scope of the claimed process. A given step or sub-set of steps can also be repeated. Furthermore, specified steps can be carried out concurrently unless explicit claim language recites that they be carried out separately. For example, a claimed step of doing X and a claimed step of doing Y can be conducted simultaneously within a single operation, and the resulting process will fall within the literal scope of the claimed process.

As used herein, any numerical value or range presented with the term “about’, “approximately”, or alike, is understood by a skilled artisan to refer to also include those values near a recited value or near the upper and lower limits of a recited range. For example, “about 40 [units]” may mean within ±25% of 40 (e.g., from 30 to 50), within ±20%, ±15%, ±10%, ±9%, ±8%, ±7%, ±7%, ±5%, ±4%, ±3%, ±2%, ±1%, less than ±1%, or any other value or range of values therein or therebelow. Also, the term “about” and “approximately” are used herein interchangeably throughout the present application.

For numerical ranges provided for certain quantities, it should be understood that these ranges also cover subranges therein. For example, the range “from 50 to 80” includes all possible ranges therein (e.g., 51-79, 52-78, 53-77, 54-76, 55-75, 70-70, etc.).

Furthermore, all values within a given range may be an endpoint for the range encompassed thereby (e.g., the range 50-80 includes the ranges with endpoints such as 55-80, 50-75, etc.).

As used herein and unless otherwise specified, the terms “about” and “approximately,” when used in connection with a numeric value or a range of values which is provided to characterize a particular solid form or state, e.g., a specific temperature or temperature range, such as, for example, that describing a melting, dehydration, desolvation or glass transition temperature; a mass change, such as, for example, a mass change as a function of temperature or humidity; a solvent or water content, in terms of, for example, mass or a percentage; or a peak position, such as, for example, in analysis by IR, Raman spectroscopy or XRPD; and to indicate that the value or range of values may deviate to an extent deemed reasonable to one of ordinary skill in the art while still describing the particular solid form. For example, in particular embodiments, the terms “about” and “approximately,” when used in this context, indicate that the numeric value or range of values may vary within 25%, 20%, 15%, 10%, 9%, 8%, 7%, 6%, 5%, 4%, 3%, 2%, 1.5%, 1%, 0.5%, or 0.25% of the recited value or range of values. As used herein, a tilde (i.e., “˜”) preceding a numerical value or range of values indicates “about” or “approximately”.

### DETAILED DESCRIPTION

The present invention will be described in detail through the following embodiments/examples with appending drawings. It should be understood that the specific embodiments are provided for an illustrative purpose only, and should not be interpreted in a limiting manner.

### EXAMPLES

### Example 1—Germ-repellent Acrylonitrile Butadiene Styrene (ABS) Plastic

### Example 1.1—ABS9

400 g of acrylonitrile butadiene styrene (ABS) base plastic is mixed with 50 g poly(ethylene glycol) ether anti-biofouling compound and 50 g styrene maleic anhydride intermediate plastic to form a masterbatch. The anti-biofouling compound, intermediate plastic, and the base plastic are mixed in a twin-screw extruder with temperatures ranging from 210° C. to 230° C.

The masterbatch is then combined with ABS base plastic. The weight ratio of base plastic:masterbatch is 65:35. The two are injection moulded together to form a germ-repellent plastic (A).

The weight percentage in the final plastic of ABS9 is: 93% ABS base plastic, 3.5% poly(ethylene glycol) ether anti-biofouling compound, and 3.5% styrene maleic anhydride intermediate plastic.

A comparative plastic made of ABS is also prepared in an identical manner, except that this comparative sample did not contain any masterbatch, anti-biofouling compound, or intermediate plastic. The comparative plastic is used as an unmodified control for comparison with germ-repellent plastic (ABS9).

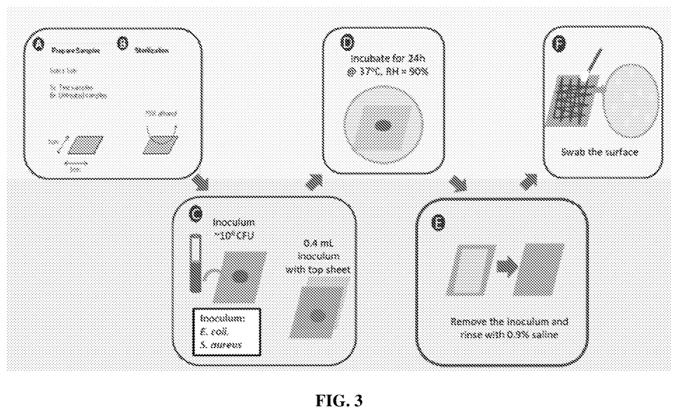

A swab test to evaluate the germ repellent efficacy is conducted on both samples by the following protocol. The germ repellent efficacy or germ repellency of a plastic can be determined by the amount of bacterial adhesion on samples fabricated from germ repellent plastic compared to the base plastic without any germ repellent additives. Plastic samples are prepared in sheet in specific dimensions and first incubated for a fixed period of time against inoculums containing a known cell number of bacteria. The inoculum preparation and the bacterial incubation procedures follow the experimental protocol of industrial standards JIS Z 2801 or ISO 22196, whereby the test and the control work pieces are incubated at 37° C.±1° C. and relative humidity of not less than 90% for 24 h±1 h. One Gram-positive bacteria strain (e.g. Staphylococcus aureus) and one Gram-negative bacteria strain (e.g. Escherichia coli) are used as representative test microbes as outlined in the said standard. After incubation, the sample will undergo a bacteria clearance step by draining off the test inoculums from the samples, rinsing, and serially diluting with 0.9% saline solution to completely remove the inoculums. The adherent bacteria from the sample surfaces are collected by swab applicator and the collected bacteria will be representative of the species conductive to colonization and biofilm growth. After serial dilution, the collected bacteria will then be cultivated onto agar plates in standard 90 mm diameter Petri dishes and their cell viability are quantified in terms of colony forming units per specimen. FIG. 3 illustrates the process workflow of an in-house germ repellent efficiency test.

In this example, six 5 cm×5 cm replicates of each sample are prepared. Bacterial suspension solutions for both S. aureus and E. coli are prepared. 1 mL of each bacterial suspension is inoculated on the surface of three replicates of each plastic sample. The inoculated samples are incubated at 37° C. for 24 hours for S. aureus and 24 hours for E. coli. Afterwards, the samples are retrieved and washed with 8 mL saline. Samples inoculated with S. aureus are washed three times; samples inoculated with E. coli, one time. A 3M swab is used to collect remaining surface bacteria. The contents of the swab are plated on agar plates and incubated at 37° C. for 24 hours. Colonies formed on the agar plate after incubation are then counted.

### Example 1.2—ABS27, ABS32, and ABS38

Similar to Example 1.1, germ repellent plastic samples ABS27, ABS32 and ABS38 in this example are prepared according to the method described in Example 1.1, except the intermediate plastic used and the ratio thereof, and the anti-fouling agent and the ratio thereof. The final product contains at least 97% ABS base plastic and 2% polypropylene glycol glycerol ether (GP330). Preferably, the final ABS base plastic in this example is at least 98% (ABS38). Some other plastic samples contained other additives such as slip additive (e.g., 1% Croda Incromax™ PS in sample ABS32, or alternatively stearyl stearate, stearyl behenate, behenyl behenate, ethyl behenate, behenyl acetate, palmityl myristate, or palmityl palmate, any other similar compounds disclosed in the UK patent under the patent number GB 2411616 A), or anti-caking/anti-setting/anti-sagging agent (e.g., 0.2% Aerosil® Pharma-200 in sample ABS27). Table 1 below summarizes the average germ repellent efficacy of different germ-repellent ABS samples (each tested in triplicates) against E. coli and S. aureus, compared to plain ABS base plastic products without any anti-fouling and/or additives.

TABLE 1

| Sample Name | S. aureus | E. coli |
|---|---|---|
| ABS38 | 98.4% | 99.9% |
| ABS32 | 93% | 88% |
| ABS27 | 88% | 99% |
| ABS9 | 92.6% | 81.9% |

As can be seen in Table 1, with E. coli, the germ-repellent plastic ABS9 of the present invention provides an 81.9% reduction in the swab test as compared to the comparative plastic; the germ-repellent plastic with the highest germ repellent efficacy against E. coli among the four samples in Examples 1.1 and 1.2 is ABS38. With S. aureus, the germ-repellent plastic with the lowest germ repellent efficacy is ABS27, whereas that with the highest germ repellent efficacy is ABS38.

For the evaluation of the tensile strength of the plastic, standard dumbbell-shaped test specimens are prepared by a specimen cutter, e.g., SDL-200HC2 specimen cutter, from specimen sheet produced via single-screw extruder. The tensile strength at yield (MPa) is evaluated, which indicates the maximum load the specimen can withstand before permanent deformation. On the stress vs. strain curve, it is shown as the tensile stress at its first peak. The tensile strength of formulations is tested by MTS® 314 Electromechanical Universal Test system under the standard of ASTM D638 “Standard Test Method for Tensile Properties of Plastics.” The Young's modulus and maximum elongation can be determined from the stress-strain curves generated. Samples are loaded onto the grips using a gauge length of 12 mm. The samples are strained at a rate of 6 mm/minute for ABS. The tensile strength of germ-repellent plastic (ABS9) is 38.6 MPa; the tensile strength of the comparative plastic (Control) is 42.2 MPa. The change in tensile strength is −8.58%.

The determination of the impact strength of the germ-repellent plastic (ABS9) is based on the standard and experimental protocol of ASTM D-256 “Standard Test Methods for Determining the Izod Pendulum Impact Resistance of Plastics.” Plastic bar specimens with specific dimensions are prepared by injection moulding machine (Thermo Scientific™, MiniJet). Then, a notch is made at a specified location on each of the plastic bar specimen. The impact strength is determined from the resistance of the plastic samples to a standardized pendulum-type hammer, mounted on a standardized machine, to breaking from a single swing. The impact strength of the germ-repellent plastic (ABS9) is 144.5 Jim; the impact strength of the comparative plastic (Control) is 217.6 J/m. The change in impact strength is −33.61%.

### Example 2—Germ-Repellent Polypropylene Homopolymer (PPH) Plastic

### Example 2.1—PPH23

350 g of polypropylene homopolymer (PPH) base plastic is mixed with 50 g polaxamer 407 anti-biofouling compound and 100 g random polyolefin grafted maleic anhydride intermediate plastic to form a masterbatch. The anti-biofouling compound, intermediate plastic, and the base plastic are mixed in a twin-screw extruder with temperatures ranging from 180° C. to 200° C.

The masterbatch is then combined with PPH base plastic. The weight ratio of base plastic:masterbatch is 88:12. The two are injection moulded together to form a germ-repellent plastic (B).

The weight percentage in the final plastic of PPH23 is: 96.4% PPH base plastic, 1.2% polaxamer 407 anti-biofouling compound, and 2.4% random polyolefin grafted maleic anhydride intermediate plastic.

A comparative plastic (Control) made of PPH is also prepared in an identical manner, except that this comparative sample did not contain any masterbatch, anti-biofouling compound, or intermediate plastic. The comparative plastic (Control) is used as an unmodified control for comparison with germ-repellent plastic.

A swab test to evaluate the germ repellent efficacy is conducted on both samples by the following protocol. Six 5 cm×5 cm replicates of each sample are prepared. Bacterial suspension solutions for both S. aureus and E. coli are prepared. 1 mL of each bacterial suspension is inoculated on the surface of three replicates of each plastic sample. The inoculated samples are incubated at 37° C. for 24 hours for S. aureus and 24 hours for E. coli. Afterwards, the samples are retrieved and washed with 8 mL saline. Samples inoculated with S. aureus are washed three times; samples inoculated with E. coli, one time. A 3M swab is used to collect remaining surface bacteria. The contents of the swab are plated on agar plates and incubated at 37° C. for 24 hours. Colonies formed on the agar plate after incubation are then counted.

### Example 2.2—PPH25, PPH42

Similar to Example 2.1, PPH is mixed with the same anti-biofouling compound and intermediate plastic, but the amount of the intermediate plastic is halved (˜1.2%) in this example. The difference between samples PPH25 and PPH42 is that the screw speed used during the extrusion (PPH25: 428 rpm; PPH42: 372 rpm). The germ repellent efficacy of different germ-repellent PPH samples against S. aureus and E. coli obtained from the swab test is summarized in Table 2.

TABLE 2

| Sample Name | S. aureus | E. coli |
|---|---|---|
| PPH23 | 94.8% | 99.2% |
| PPH25 | 95.8% | 96.3% |
| PPH42 | 98.0% | 97.9% |

As can be seen in Table 2, with E. coli, the germ-repellent plastic PPH23 of the present invention provides a 99.2% reduction in the swab test as compared to the comparative plastic (Control), which is the highest among the three samples; the lowest is PPH25. With S. aureus, the germ-repellent plastic with the highest germ repellent efficacy is PPH42; the lowest is PPH23. In Example 2.2, using a slower screw speed during extrusion will result in an improvement in overall germ repellent efficacy against two bacterial strains.

For the evaluation of the tensile strength of the plastic, standard dumbbell-shaped test specimens are prepared by a specimen cutter from specimen sheet produced via single-screw extruder. The tensile strength at yield (MPa) is evaluated, which indicates the maximum load the specimen can withstand before permanent deformation. On the stress vs. strain curve, it is shown as the tensile stress at its first peak. The tensile strength of formulations is tested by MTS® 314 Electromechanical Universal Test system under the standard of ASTM D638 “Standard Test Method for Tensile Properties of Plastics.” Samples are loaded onto the grips using a gauge length of 12 mm. The samples are strained at a rate of 5 mm/minute for PPH. The tensile strength of germ-repellent plastic (PPH23) is 34.5 MPa; the tensile strength of the comparative plastic (Control) is 36.0 MPa. The change in tensile strength is −4.24%.

The determination of the impact strength of the germ-repellent plastic (PPH23) is based on the standard and experimental protocol of ASTM D-256 “Standard Test Methods for Determining the Izod Pendulum Impact Resistance of Plastics.” Plastic bar specimens with specific dimensions are prepared by injection moulding machine (Thermo Scientific™, MiniJet). Then, a notch is made at a specified location on each of the plastic bar specimen. The impact strength is determined from the resistance of the plastic samples to a standardized pendulum-type hammer, mounted on a standardized machine, to breaking from a single swing. The impact strength of the germ-repellent plastic (PPH23) is 14.7 Jim; the impact strength of the comparative plastic (Control) is 15.5 J/m. The change in impact strength is −4.72%.

### Example 2.3—PPH15

350 g of polypropylene homopolymer (PPH) base plastic is mixed with 50 g polaxamer 407 anti-biofouling compound and 100 g random polyolefin grafted maleic anhydride intermediate plastic to form a masterbatch. The anti-biofouling compound, intermediate plastic, and the base plastic are mixed in a twin-screw extruder with temperatures ranging from 180° C. to 200° C.

The masterbatch is then combined with PPH base plastic. The weight ratio of base plastic:masterbatch is 92:8. The two are injection moulded together to form a germ-repellent plastic (E).

The weight percentage in the final plastic of (E) is: 97.6% PPH base plastic, 0.8% polaxamer 407 anti-biofouling compound, and 1.6% random polyolefin grafted maleic anhydride intermediate plastic.

A comparative plastic (Control 5) made of PPH is also prepared in an identical manner, except that this comparative sample did not contain any masterbatch, anti-biofouling compound, or intermediate plastic. The comparative plastic (Control 5) is used as an unmodified control for comparison with germ-repellent plastic (E).

A swab test to evaluate the germ repellent efficacy is conducted on both samples by the following protocol. Three 5 cm×5 cm replicates of each sample are prepared. Bacterial suspension solution for S. aureus is prepared. 1 mL of the bacterial suspension is inoculated on the surface of three replicates of each plastic sample. The inoculated samples are incubated at 37° C. for 24 hours. Afterwards, the samples are retrieved and washed with 8 mL saline three times. A 3M swab is used to collect remaining surface bacteria. The contents of the swab are plated on agar plates and incubated at 37° C. for 24 hours. Colonies formed on the agar plate after incubation are then counted.

TABLE 3

| Sample Name | S. aureus | E. coli |
|---|---|---|
| PPH15 | 93.7% | N/A |

As can be seen in Table 3, with S. aureus, the germ-repellent plastic (PPH15) of the present invention provides a 93.7% reduction in the swab test as compared to the comparative plastic (Control).

### Example 2.4—PPH3

400 g of ethylene, butyl acrylate, and maleic anhydride random terpolymer intermediate plastic is mixed with 30 g of poly(ethylene glycol) ether anti-biofouling compound to form a masterbatch. The anti-biofouling compound and intermediate plastic are mixed in a twin-screw extruder with temperatures ranging from 110° C. to 200° C.

The masterbatch is then combined with polypropylene homopolymer (PPH) base plastic. The weight ratio of base plastic:masterbatch is 80:16. The two are injection moulded together to form a germ-repellent plastic (PPH3).

The weight percentage in the final plastic of (PPH3) is: 83.3% PPH base plastic, 1.2% poly(ethylene glycol) ether anti-biofouling compound, and 15.5% ethylene, butyl acrylate, and maleic anhydride random terpolymer intermediate plastic.

A comparative plastic (Control) made of PPH is also prepared in an identical manner, except that this comparative sample did not contain any masterbatch, anti-biofouling compound, or intermediate plastic. The comparative plastic (Control) is used as an unmodified control for comparison with germ-repellent plastic (PPH3).

A swab test to evaluate the germ repellent efficacy is conducted on both samples by the following protocol. Three 5 cm×5 cm replicates of each sample are prepared. Bacterial suspension solution for E. coli is prepared. 1 mL of the bacterial suspension is inoculated on the surface of three replicates of each plastic sample. The inoculated samples are incubated at 37° C. for 24 hours. Afterwards, the samples are retrieved and washed with 8 mL saline one time. A 3M swab is used to collect remaining surface bacteria. The contents of the swab are plated on agar plates and incubated at 37° C. for 24 hours. Colonies formed on the agar plate after incubation are then counted.

TABLE 4

| Sample Name | S. aureus | E. coli |
|---|---|---|
| PPH3 | N/A | 89.4% |

As can be seen in Table 4, with E. coli, the germ-repellent plastic (PPH3) of the present invention provides an 89.4% reduction in the swab test as compared to the comparative plastic (Control).

### Example 2.5—PPH37

375 g of polypropylene homopolymer (PPH) base plastic is mixed with 50 g polaxamer 407 anti-biofouling compound and 75 g polypropylene grafted maleic anhydride intermediate plastic to form a masterbatch. The anti-biofouling compound, intermediate plastic, and the base plastic are mixed in a twin-screw extruder with temperatures ranging from 180° C. to 200° C.

The masterbatch is then combined with PPH base plastic. The weight ratio of base plastic:masterbatch is 88:12. The two are injection moulded together to form a germ-repellent plastic (F).

The weight percentage in the final plastic of (PPH37) is: 97.0% PPH base plastic, 1.2% polaxamer 407 anti-biofouling compound, and 1.8% polypropylene grafted maleic anhydride intermediate plastic.

A comparative plastic (Control) made of PPH is also prepared in an identical manner, except that this comparative sample did not contain any masterbatch, anti-biofouling compound, or intermediate plastic. The comparative plastic (Control) is used as an unmodified control for comparison with germ-repellent plastic (PPH37).

A swab test to evaluate the germ repellent efficacy is conducted on both samples by the following protocol. Six 5 cm×5 cm replicates of each sample are prepared. Bacterial suspension solutions for both S. aureus and E. coli are prepared. 1 mL of each bacterial suspension is inoculated on the surface of three replicates of each plastic sample. The inoculated samples are incubated at 37° C. for 24 hours for S. aureus and 48 hours for E. coli. Afterwards, the samples are retrieved and washed with 8 mL saline. Samples inoculated with S. aureus are washed three times; samples inoculated with E. coli, one time. A 3M swab is used to collect remaining surface bacteria. The contents of the swab are plated on agar plates and incubated at 37° C. for 24 hours. Colonies formed on the agar plate after incubation are then counted.

TABLE 5

| Sample Name | S. aureus | E. coli |
|---|---|---|
| PPH37 | 87.6% | 95.6% |

As can be seen in Table 5, with E. coli, the germ-repellent plastic (PPH37) of the present invention provides a 95.6% reduction in the swab test as compared to the comparative plastic (Control); and a 87.6% reduction of bacterial growth of S. aureus.

### Example 2.6—PPH38

425 g of polypropylene homopolymer (PPH) base plastic is mixed with 50 g polaxamer 407 anti-biofouling compound and 25 g polypropylene grafted maleic anhydride intermediate plastic to form a masterbatch. The anti-biofouling compound, intermediate plastic, and the base plastic are mixed in a twin-screw extruder with temperatures ranging from 180° C. to 200° C.

The masterbatch is then combined with PPH base plastic. The weight ratio of base plastic:masterbatch is 88:12. The two are injection moulded together to form a germ-repellent plastic (PPH38).

The weight percentage in the final plastic of (PPH38) is: 98.2% PPH base plastic, 1.2% polaxamer 407 anti-biofouling compound, and 0.6% polypropylene grafted maleic anhydride intermediate plastic.

A comparative plastic (Control) made of PPH is also prepared in an identical manner, except that this comparative sample did not contain any masterbatch, anti-biofouling compound, or intermediate plastic. The comparative plastic (Control) is used as an unmodified control for comparison with germ-repellent plastic (PPH38).

A swab test to evaluate the germ repellent efficacy is conducted on both samples by the following protocol. Six 5 cm×5 cm replicates of each sample are prepared. Bacterial suspension solutions for both S. aureus and E. coli are prepared. 1 mL of each bacterial suspension is inoculated on the surface of three replicates of each plastic sample. The inoculated samples are incubated at 37° C. for 24 hours for S. aureus and 48 hours for E. coli. Afterwards, the samples are retrieved and washed with 8 mL saline. Samples inoculated with S. aureus are washed three times; samples inoculated with E. coli, one time. A 3M swab is used to collect remaining surface bacteria. The contents of the swab are plated on agar plates and incubated at 37° C. for 24 hours. Colonies formed on the agar plate after incubation are then counted.

TABLE 6

| Sample Name | S. aureus | E. coli |
|---|---|---|
| PPH38 | 92.4% | 95.6% |

As can be seen in Table 6, with E. coli, the germ-repellent plastic (PPH38) of the present invention provides a 95.6% reduction in the swab test as compared to the comparative plastic (Control); and a 92.4% reduction of bacterial growth of S. aureus.

### Example 2.7—PPH39

400 g of polypropylene homopolymer (PPH) base plastic is mixed with 50 g polaxamer 407 anti-biofouling compound and 50 g polypropylene grafted maleic anhydride intermediate plastic to form a masterbatch. The anti-biofouling compound, intermediate plastic, and the base plastic are mixed in a twin-screw extruder with temperatures ranging from 180° C. to 200° C.

The masterbatch is then combined with PPH base plastic. The weight ratio of base plastic:masterbatch is 88:12. The two are injection moulded together to form a germ-repellent plastic (PPH39).

The weight percentage in the final plastic of (PPH39) is: 97.6% PPH base plastic, 1.2% polaxamer 407 anti-biofouling compound, and 1.2% polypropylene grafted maleic anhydride intermediate plastic.

A comparative plastic (Control 8) made of PPH is also prepared in an identical manner, except that this comparative sample did not contain any masterbatch, anti-biofouling compound, or intermediate plastic. The comparative plastic (Control 8) is used as an unmodified control for comparison with germ-repellent plastic (PPH39).

A swab test to evaluate the germ repellent efficacy is conducted on both samples by the following protocol. Six 5 cm×5 cm replicates of each sample are prepared. Bacterial suspension solutions for both S. aureus and E. coli are prepared. 1 mL of each bacterial suspension is inoculated on the surface of three replicates of each plastic sample. The inoculated samples are incubated at 37° C. for 24 hours for S. aureus and 48 hours for E. coli. Afterwards, the samples are retrieved and washed with 8 mL saline. Samples inoculated with S. aureus are washed three times; samples inoculated with E. coli, one time. A 3M swab is used to collect remaining surface bacteria. The contents of the swab are plated on agar plates and incubated at 37° C. for 24 hours. Colonies formed on the agar plate after incubation are then counted.

TABLE 7

| Sample Name | S. aureus | E. coli |
|---|---|---|
| PPH39 | 88.0% | 74.2% |

As can be seen in Table 7, with E. coli, the germ-repellent plastic (PPH39) of the present invention provides a 74.2% reduction in the swab test as compared to the comparative plastic (Control); and a 88.0% reduction of bacterial growth of S. aureus.

### Example 3—Germ-Repellent Polypropylene Impact Copolymer (PPIC) Plastic

### Example 3.1—IC12

Polypropylene impact copolymer (PPIC) is mixed with Atmer™ 7373 (an anti-fog additive from Croda), anti-biofouling compound at a weight ratio of base plastic:anti-biofouling compound of 98:2. They are mixed in a single-screw extruder with temperatures ranging from 110° C. to 190° C. The extruded sheets form germ-repellent plastic (IC12).

The weight percentage in the final plastic of (IC12) is: 98% PPIC base plastic and 2% Atmer™ 7373 anti-biofouling compound.

A comparative plastic (Control) made of PPIC is also prepared in an identical manner, except that this comparative sample did not contain any masterbatch, anti-biofouling compound, or intermediate plastic. The comparative plastic (Control) is used as an unmodified control for comparison with germ-repellent plastic (IC12).

A swab test to evaluate the germ repellent efficacy is conducted on both samples by the following protocol. Three 5 cm×5 cm replicates of each sample are prepared. Bacterial suspension solution for E. coli is prepared. 1 mL of the bacterial suspension is inoculated on the surface of three replicates of each plastic sample. The inoculated samples are incubated at 37° C. for 24 hours. Afterwards, the samples are retrieved and washed with 8 mL saline one time. A 3M swab is used to collect remaining surface bacteria. The contents of the swab are plated on agar plates and incubated at 37° C. for 24 hours. Colonies formed on the agar plate after incubation are then counted.

TABLE 8

| Sample Name | S. aureus | E. coli |
|---|---|---|
| IC12 | N/A | 96.1% |

As can be seen in Table 8, with E. coli, the germ-repellent plastic (IC12) of the present invention provides a 96.1% reduction in the swab test as compared to the comparative plastic (Control).

### Example 3.2—IC19, IC22

Compared to Example 3.1, a lower amount of PPIC is used in this example, e.g., at about 95.2%; a different anti-biofouling compound at about 2.4% is used, e.g., polyethylene glycol ether (for IC19) or polypropylene glycol glycerol ether (for IC22); an additional intermediate plastic, e.g., random polyolefin grafted maleic anhydride, at about 2.4% is incorporated. The germ-repellent efficacy of these two samples against E. coli and S. aureus is summarized in the following Table.

TABLE 9

| Sample Name | S. aureus | E. coli |
|---|---|---|
| IC19 | 96.1% | 99.2% |
| IC22 | 97.8% | 96.7% |

As can be seen from Table 9, both IC19 and IC22 are effective in reducing the bacterial growth of both bacterial strains after incorporation of a different anti-biofouling compound from Example 3.1 and an additional intermediate plastic.

### INDUSTRIAL APPLICABILITY

The present invention is applicable in various plastic products in substantially all shapes and dimensions with durable and effective anti-biofouling properties while mechanical properties are substantially unchanged or the change is minor after being introduced with the hydrophilic additives, in particular, for those plastic products required to meet the standards such as BS1254:1981, BS EN 274-2:2002, BS EN 997, BS 1125:1987, WELS standard, HKHA standard, etc. For example, the present invention is applicable in toilet seat, waste trap/drainage pipes, flush valve, cistern, shower head, etc.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. A germ-repellent polymer structure comprising:
a base plastic selected from polypropylene homopolymer, polypropylene impact copolymer, or acrylonitrile butadiene styrene; and
a hydration layer, the hydration layer comprising one or more hydrophilic additives and being surface-grafted on the base plastic directly or in the presence of an intermediate plastic that is compatible to both the base plastic and the hydrophilic additives for stabilizing the hydration layer on the base plastic;
wherein the germ-repellent polymer structure has at least 90% reduction in bacterial growth and maximum 20% change in mechanical strength from an original mechanical strength, the original mechanical strength corresponding to a strength of the base plastic before formation of the hydration layer on the base plastic.

30. The germ-repellent polymer structure of claim 29, wherein the one or more hydrophilic additive is/are mixed in a range of approximately 0.1 to 20 wt. % with the base plastic in a range of approximately 60 to 99 wt. % through the intermediate plastic in a range of approximately 0 to 20 wt. %, and wherein said intermediate plastic is selected from a maleic anhydride grafted copolymer having at least one polymeric segment compatible to the base plastic.

31. The germ-repellent polymer structure of claim 29, wherein the one or more hydrophilic additives is/are selected from a hydrophilic non-ionic surfactant having at least one hydrophilic block of polyethylene glycol.

32. The germ-repellent polymer structure of claim 31, wherein the one or more hydrophilic additives is a triblock copolymer having two hydrophilic blocks of polyethylene glycol on both ends sandwiching a central hydrophobic block of polypropylene glycol with the following formula: 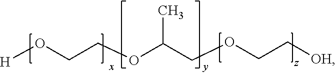
wherein x:y:z is 98-101:56:98-101.

33. The germ-repellent polymer structure of claim 31, wherein the one or more hydrophilic additives is a polyethylene glycol ether with the following formula: 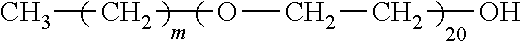
wherein m=15 or 17; or 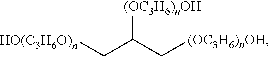
wherein n is 16-20.

34. The germ-repellent polymer structure of claim 29, wherein the one or more hydrophilic additives is polyethylene glycol sorbitol hexaoleate.

35. The germ-repellent polymer structure of claim 29, further comprising a slip additive for reducing surface friction and facilitating mold release, wherein the slip additive is selected from stearyl stearate, stearyl behenate, behenyl behenate, ethyl behenate, behenyl acetate, palmityl myristate, or palmityl palmate, or any other compounds.

36. The germ-repellent polymer structure of claim 29, wherein the one or more hydrophilic additives is/are in a range of 0.1 to 5 wt. %; the base plastic is in a range of 85 to 99.9 wt. %; the intermediate plastic is in a range of 0 to 10 wt. %.

37. The germ-repellent polymer structure of claim 32, wherein the triblock copolymer associates with the one or more hydrophilic additives to orient the polyethylene glycol moiety of the hydrophilic additive towards the surface of the base plastic such that a reduction by at least 95% of the bacterial growth on said base plastic surface is resulted.

38. The germ-repellent polymer structure of claim 29, wherein said bacterial growth on said surface of the base plastic is a biofilm formed by bacteria selected from E. coli or S. aureus.

39. The germ-repellent polymer structure of claim 30, wherein the base plastic, the one or more hydrophilic additives and the intermediate plastic form a masterbatch.

40. The germ-repellent polymer structure of claim 39, wherein said comingling comprises melt extrusion.

41. A method of making a germ-repellent plastic including the germ-repellent polymer structure of claim 29, the method comprising:
preparing a masterbatch comprising two or more of base plastic, hydrophilic additive and intermediate plastic;
injection molding base plastic and the masterbatch to form the germ-repellent polymer structure with germ-repellent properties of approximately 90% or higher reduction in bacterial growth on the surface of the base plastic,
wherein the base plastic is one or more selected from acrylonitrile butadiene styrene (ABS), polypropylene homopolymer (PPH), and/or polypropylene impact copolymer (PPIC); the hydrophilic additive is one or more selected from polypropylene glycol glycerol ether, poly(ethylene glycol) ether, polaxamer 407, and/or an anti-fog additive; the intermediate plastic is one or more selected from styrene maleic anhydride (SMA), random polyolefin grafted maleic anhydride, ethylene, butyl acrylate, and maleic anhydride random terpolymer, and/or polypropylene grafted maleic anhydride.

42. The method of claim 41, wherein the masterbatch is prepared by comingling approximately 0.1 to 20 wt. % of one or more hydrophilic additives, 60 to 90 wt. % of base plastic, and 0 to 20 wt. % of intermediate plastic at a first temperature of 110 to 230° C.

43. The method of claim 41, wherein the preparing of the masterbatch includes selecting the hydrophilic additives to match the base plastic before comingling thereof with one or both of the base plastic and/or intermediate plastic, selecting the hydrophilic additives that are capable of being homogeneously dispersed in the base plastic during a molten phase in extrusion and orienting the hydrophilic moiety of the hydrophilic additives to the surface of the base plastic during cooling phase after extrusion.

44. The method of claim 41, wherein the intermediate plastic of the present invention includes a portion that is compatible to the polymer matrix of the base plastic and a portion that is incompatible to the polymer matrix of the base plastic but is compatible to the hydrophilic additives and to facilitate the orientation of the hydrophilic moiety of the hydrophilic additives to the surface of the base plastic.

45. The method of claim 41, further comprising adding a slip additive before the injection molding, wherein the slip additive is selected from stearyl stearate, stearyl behenate, behenyl behenate, ethyl behenate, behenyl acetate, palmityl myristate, or palmityl palmate, or any other compounds capable of lowering friction of the base plastic during injection molding.

46. The method of claim 41, wherein the base plastic, hydrophilic additive and intermediate plastic are mixed to form the masterbatch followed by extruding the masterbatch and the base plastic to form the germ-repellent polymer structure.

47. The method of claim 41, further comprising pelletizing the germ-repellent plastic after cooling from extrusion.

48. The method of claim 41, wherein said bacterial growth on said surface of the base plastic is a biofilm formed by bacteria selected from E. coli or S. aureus.
